(19) United States
(12) Patent Application Publication
(10) Pub. No.: US 2019/0030742 A1
(43) Pub. Date: Jan. 31, 2019

(54) LAMINATOR WITH CUTTER

(71) Applicant: Guangdong Willing Technology Corporation, Huizhou (CN)

(72) Inventor: JINGNONG YE, Huizhou (CN)

(21) Appl. No.: 15/658,423

(22) Filed: Jul. 25, 2017

(51) Int. Cl. B26D 5/10; B26D 7/01; B26D 1/30

(52) U.S. Cl. CPC B26D 5/10; B26D 1/305; B26D 7/015

(57) ABSTRACT

The laminator includes a laminating member with a flat cutting platform, a pivot disposed at a corner of the laminating member, and a cutter assembly having a first end rotatably hinged to the laminating member through the pivot. After a document is laminated by the laminating member, the laminated document may be trimmed by the cutter assembly for enhanced convenience and safety.

### BACKGROUND OF THE INVENTION

### (a) Technical Field of the Invention

The present invention generally relates to the application of adhesive to objects and, more particularly, to a laminator capable of adjusting amount and manner of adhesive application.

### (b) Description of the Prior Art

To prevent important paper documents, such as certificates and photos, from becoming damp or damaged, these paper documents are often laminated with a layer of transparent plastic using a laminator. Then the rugged edges of the laminated documents are smoothed by a cutter.

A cutter is a common tool in offices for cutting papers. Using lever principle, the knife of the cutter may cut a large set of papers with limited force. A cutter is therefore also suitable for cutting the thicker laminated paper documents.

There are laminators integrated with cutters. However they are most used in an industrial setting, not for personal use. These integrated laminators usually provide slide cutting or vertical cutting. But these two cutting methods are not ideal for laminated documents. Sliding cutting usually offsets the documents, causing cutting errors. Vertical cutting requires a larger force, sometimes causing damage or deformation to the documents.

The present invention therefore arises out of the need to obviate the shortcomings of the existing laminators with integrated cutting capability.

### SUMMARY OF THE INVENTION

Therefore, a novel laminator is provided here so as to obviate the shortcomings of the prior art.

A major objective of the present invention is to integrate a laminator and a cutter so as to reduce cost of ownership and storage space.

Another major objective of the present invention is to perform cutting through the lever principle so that thicker or harder documents may be cut reliably.

The laminator includes a laminating member with a flat cutting platform, a pivot disposed at a corner of the laminating member, and a cutter assembly having a first end rotatably hinged to the laminating member through the pivot. To use the laminator, a document is first laminated through the laminating member. The laminated document is then placed and accurately cut on the cutting platform. As the cutter assembly is operated through the lever principle and a maximum torque is applied, the laminator is therefore appropriate to cut the laminated document with a higher thickness or hardness with enhanced precision and reliability.

As described, the present invention therefore may resolve the prior art's problems such as cutting errors caused by document offset, or damage/deformation to the thicker and harder laminated documents when a larger force is required.

The foregoing objectives and summary provide only a brief introduction to the present invention. To fully appreciate these and other objects of the present invention as well as the invention itself, all of which will become apparent to those skilled in the art, the following detailed description of the invention and the claims should be read in conjunction with the accompanying drawings. Throughout the specification and drawings, identical reference numerals refer to identical or similar parts.

Many other advantages and features of the present invention will become manifest to those versed in the art upon making reference to the detailed description and the accompanying sheets of drawings in which a preferred structural embodiment incorporating the principles of the present invention is shown by way of illustrative example.

### BRIEF DESCRIPTION OF THE DRAWINGS

FIG. 1 is a perspective diagram showing a laminator according to an embodiment of the present invention.

FIG. 2 is another perspective diagram showing the laminator of FIG. 1 from a different angle.

FIG. 3 is another perspective diagram showing the laminator of FIG. 1 where a document is prepared for cutting.

FIG. 4 is a schematic diagram showing the laminator of FIG. 3 where the document is positioned and pressurized.

FIG. 5 is another perspective diagram showing the laminator of FIG. 3 when the document is about to be cut.

### DETAILED DESCRIPTION OF THE PREFERRED EMBODIMENTS

The following descriptions are exemplary embodiments only and are not intended to limit the scope, applicability or configuration of the invention in any way. Rather, the following description provides a convenient illustration for implementing exemplary embodiments of the invention. Various changes to the described embodiments may be made in the function and arrangement of the elements described without departing from the scope of the invention as set forth in the appended claims.

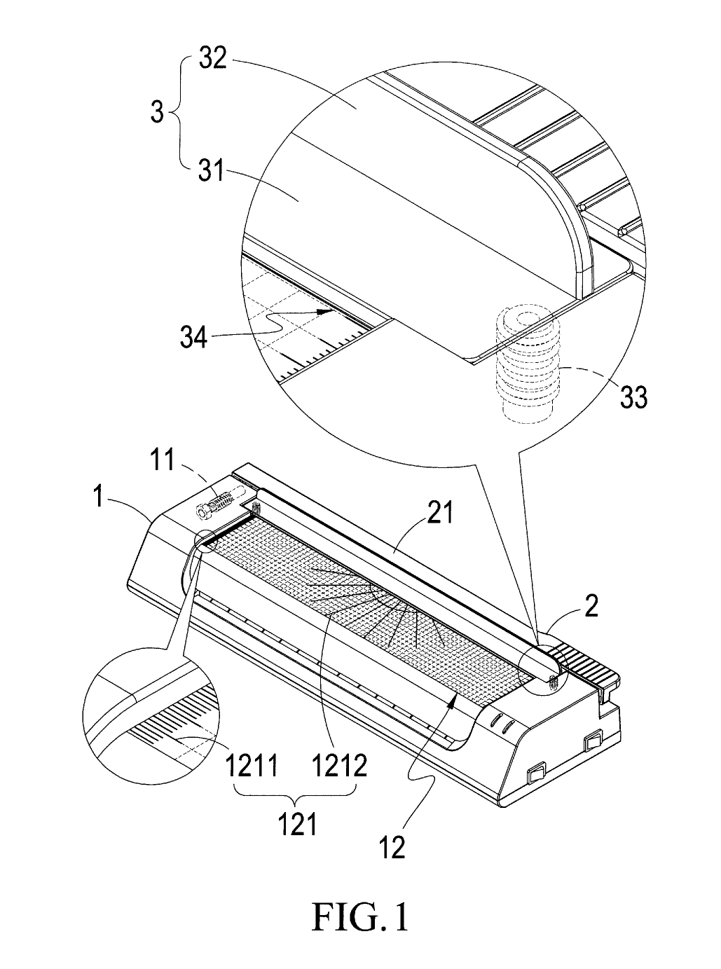

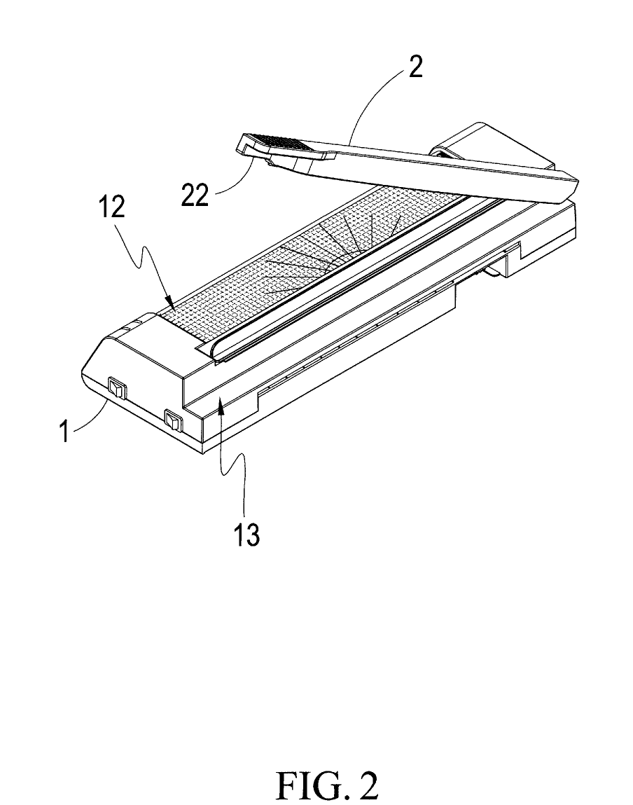

As shown in FIGS. 1 and 2, a laminator according to an embodiment of the present invention includes the following components.

A laminating member 1 has a flat cutting platform 12 and a trough 13 along a major edge of the cutting platform 12.

A pivot 11 is disposed at a corner of the laminating member 1 adjacent to an end of the trough 13.

An elongated cutter assembly 2 has a first end rotatably hinged to the laminating member 1 through the pivot 11. The cutter assembly 2 therefore may be received in the trough 13. The cutter assembly 2 has a flat top face 21. When the cutter assembly 2 is received in the trough 13, the top face 21 is level with a top side of the cutting platform 12.

The cutter assembly 2 further has a notch 22 on a bottom edge at a second end of the cutter assembly 2 opposite to the first end.

An elongated guard element 3 is disposed on the cutting platform 12 along the trough 13. The guard element 3 has a flat piece 31 and a vertical piece 32 extended from a top side of the flat piece 31.

A set of markings 121 is provided on the cutting platform 12, and includes a ruler marking 1211 and a protractor marking 1212 to a side of the ruler marking 1211.

A number of elastic elements 33 is positioned between the guard element 3 and the cutting platform 12. The guard element 3 is therefore elastically raised above the cutting platform 12 with a gap 34 between the guard element 3 and the cutting platform 12.

As described above, the present invention integrates a laminator and a cutter into a single device that provides precise cutting to laminated objects. The operation of the cutter-integrated laminator is as follows.

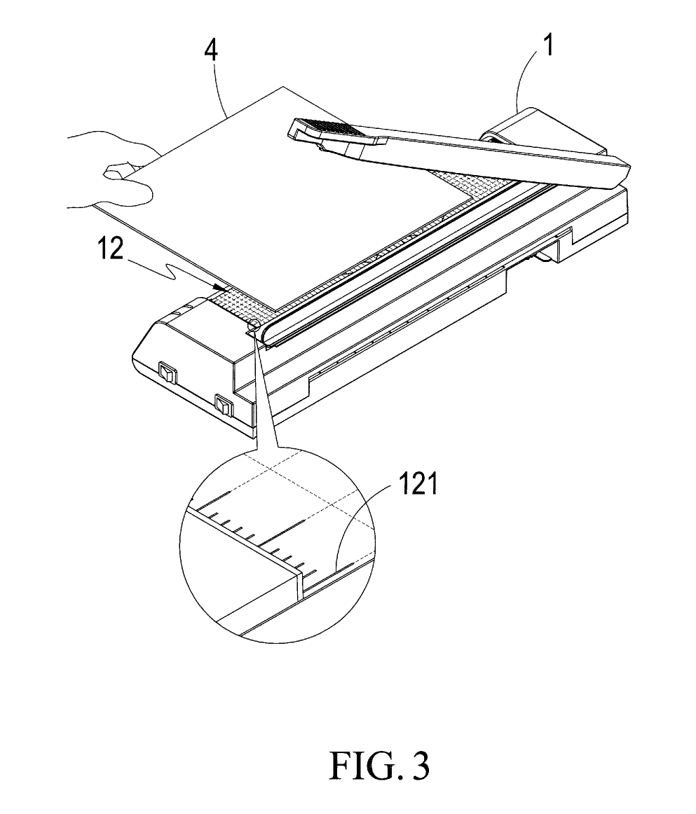

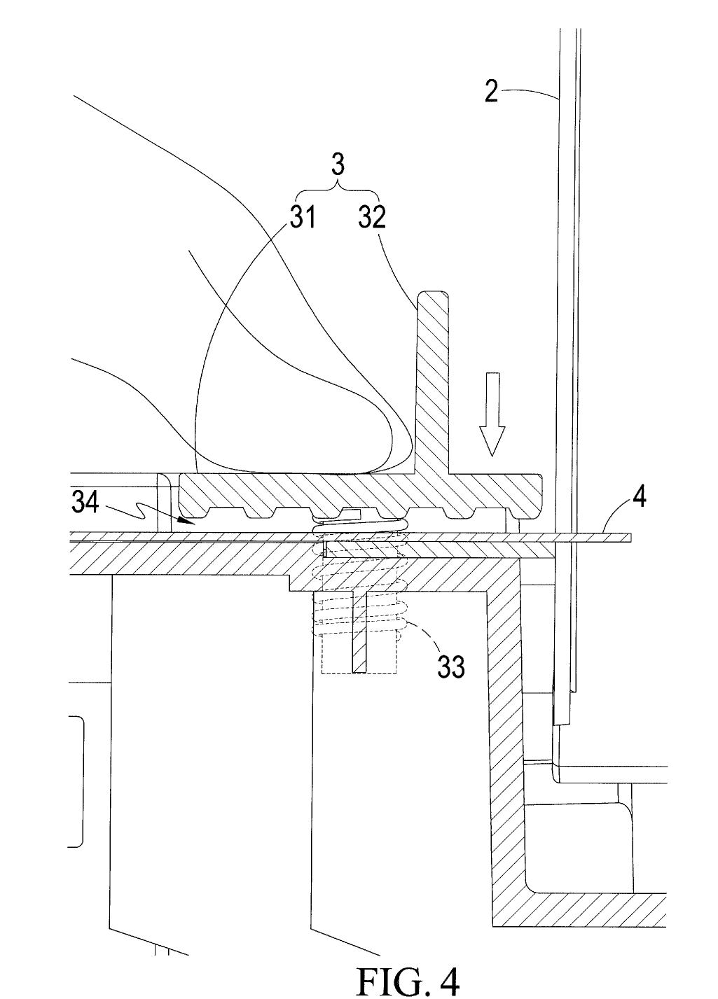

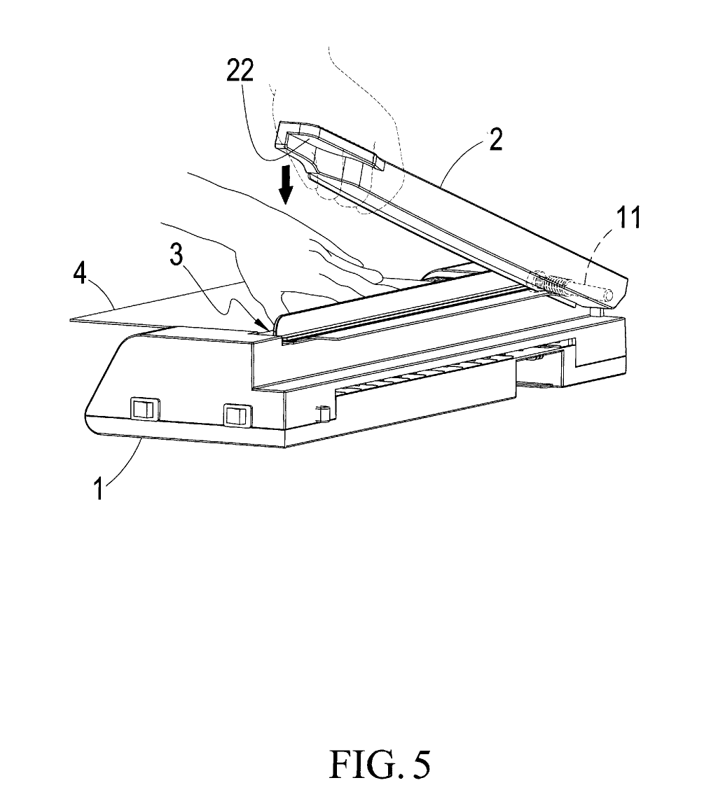

As shown in FIGS. 1 to 5, the cutter assembly 2 is pivotally joined to the laminating member 1 by the pivot 11 and therefore provides the greatest torque through the lever principle when cutting is conducted. In addition, the cutter assembly 2 is entirely received by the trough 13 and has its top face 21 level with the cutting platform. As such, when the cutter assembly 2 is not used, it may be neatly incorporated to the laminating member 1, and appears as an integral part of the laminating member 1.

To use the laminator, a document 4 is first laminated through the laminating member 1. The laminated document 4 is then placed on the cutting platform 12 with the edge to be trimmed slid through the gap 34. The document 4 may be precisely positioned using the set of markings 121. For example, the ruler marking 1211 may be used to adjust the length and width for the portion of the document 4 to be cut. In addition, the protractor marking 1212 may be used to tilt the document 4 for an appropriate angle. Then the document 4 may be accurately cut on the cutting platform 12.

To perform cutting, a user holds the notch 22 to lift the cutter assembly 2 out of the trough 13 with one hand, and presses the flat piece 31 to compress the elastic elements 33 so that the guard element 3 descends to pressurize the document 4. Through the guard element 3, the pressure is uniformly distributed over the document 4 and the document 4 as such is held steadily and reliably during cutting without mistake. The user's fingers are prevented from sliding and also protected by the vertical piece 32 for enhanced safety. In addition, as the cutter assembly 2 is operated through the lever principle and a maximum torque is applied, the laminator of the present invention is therefore appropriate to cut the laminated document with a higher thickness or hardness.

While certain novel features of this invention have been shown and described and are pointed out in the annexed claim, it is not intended to be limited to the details above, since it will be understood that various omissions, modifications, substitutions and changes in the forms and details of the device illustrated and in its operation can be made by those skilled in the art without departing in any way from the claims of the present invention.

I claim:

1. A laminator, comprising:
a laminating member comprising a flat cutting platform;
a pivot disposed at a corner of the laminating member; and
a cutter assembly having a first end rotatably hinged to the laminating member through the pivot.

2. The laminator according to claim 1, further comprising a guard element disposed on the cutting platform along the cutter assembly.

3. The laminator according to claim 2, wherein the guard element comprises a flat piece and a vertical piece extended from a top side of the flat piece.

4. The laminator according to claim 3, wherein at least an elastic elements is positioned between the guard element and the cutting platform so that the guard element 3 is elastically raised above the cutting platform.

5. The laminator according to claim 4, wherein a gap is provided between the guard element and the cutting platform.

6. The laminator according to claim 1, wherein the laminating member further comprises a trough along a major edge of the cutting platform for receiving the cutter assembly.

7. The laminator according to claim 6, wherein the cutter assembly has a flat top face; and, when the cutter assembly is received in the trough, the top face is level with a top side of the cutting platform.

8. The laminator according to claim 1, wherein the cutter assembly further has a notch on a bottom edge at a second end of the cutter assembly opposite to the first end.

9. The laminator according to claim 1, wherein a set of markings is provided on the cutting platform.

10. The laminator according to claim 9, wherein the set of markings comprises and a ruler marking and a protractor marking to a side of the ruler marking.
